(19) United States
(12) Patent Application Publication
(10) Pub. No.: US 2016/0351875 A1
(43) Pub. Date: Dec. 1, 2016

(54) SEPARATOR FOR LITHIUM SECONDARY BATTERY AND METHOD OF PREPARING THE SAME

(71) Applicant: UNIST (ULSAN NATIONAL INSTITUTE OF SCIENCE AND TECHNOLOGY), Ulsan (KR)

(72) Inventors: Soojin PARK, Ulsan (KR); Sang Young LEE, Busan (KR); Seungmin YOO, Ulsan (KR); Jung Hwan KIM, Ulsan (KR)

(73) Assignee: UNIST(ULSAN NATIONAL INSTITUTE OF SCIENCE AND TECHNOLOGY), Ulsan (KR)

(21) Appl. No.: 15/114,437

(22) PCT Filed: Feb. 4, 2015
(86) PCT No.: PCT/KR2015/001152

§ 371 Date: Jul. 27, 2016

(30) Foreign Application Priority Data
Feb. 4, 2014 (KR) 10-2014-0012418

(51) Int. Cl. H01M 2/16; H01M 2/14; C08F 8/42; H01M 10/0525

(52) U.S. Cl. CPC H01M 2/1653; H01M 10/0525; H01M 2/145; C08F 8/42

(57) ABSTRACT

A separator for a lithium secondary battery and a method of preparing the same are disclosed. The method of preparing a separator for a lithium secondary battery includes: preparing a block copolymer; incorporating a functional group into the block copolymer; and pores in the block copolymer with the functional group incorporated thereinto.

### TECHNICAL FIELD

The present invention relates to a separator for a lithium secondary battery which uses a block copolymer.

### BACKGROUND ART

Interest in various types of energy conversion devices is growing fast as energy storage and conversion technologies have become increasingly important. Among them, lithium secondary batteries are getting much attention.

In a lithium secondary battery, one of the most important elements that affect battery characteristics is a separator that is located between the anode and cathode of the battery.

The separator functions as a path for lithium ions to travel, as well as preventing a short-circuit between the anode and cathode of the lithium ion battery. Accordingly, the separator needs to have a high porosity and a uniform porous structure so as to ensure desired ionic conductivity by fulfilling its function as an ion path.

In addition to ionic conductivity, the separator requires thermal stability and excellent electrolyte solution wettability.

Also, although the separator is located between the anode and cathode and is basically inert because of their lack of participation in any electrochemical reactions, the battery performance can be improved through the incorporation of a functional group.

Therefore, there is a lot of research going on about separators for lithium secondary batteries which offer excellent ionic conductivity and excellent thermal stability and electrolyte wettability because of their uniform porous structure.

### DISCLOSURE

### Technical Problem

The present invention has been made in an effort to provide a functional separator for a high-performance lithium secondary battery which can form a highly porous structure through microphase separation in block copolymers by using a difference in solvent selectivities, and which can absorb unnecessary by-products in the electrolyte, and a method of preparing the same.

### Technical Solution

An exemplary embodiment of the present invention provides a separator for a lithium secondary battery, including a block copolymer represented by the following Chemical Formula 1:

A-block-B [Chemical Formula 1]

where A and B are the same or different, and may be each independently one selected from the group consisting of polystyrene, polyisoprene, poly(2-vinylpyridine), poly(4-vinylpyridine), poly(methyl methacrylate), poly(t-butyl methacrylate), poly(acrylic acid), poly(ε-Caprolactone), poly(dimethylsiloxane), poly(n-butyl methyl methacrylate), poly(2-vinyl naphthalene), poly(n-butyl acrylate), poly(I-butyl acrylate), poly(4-hydroxyl styrene), poly(4-methoxy styrene), poly(t-butyl styrene), poly(bipyridylmethyl acrylate), poly(benzyl propylacrylate), 1,2-polybutadiene, 1,4-polybutadiene, poly(ferrocenyldimethylsilane), poly(lactide), poly(vinyl pyrrolidone), poly(D/L-lactide), poly(ethylene oxide), poly(propylene oxide), poly(acrylamide), and poly(ethylene), or a derivative thereof, or a mixture thereot.

A separator for a lithium secondary battery according to another exemplary embodiment of the present invention includes a block copolymer represented by the following Chemical Formula 2:

A-block-B-block-C [Chemical Formula 2]

where A, B, and C are the same or different, and may be each independently one selected from the group consisting of polystyrene, polyisoprene, poly(2-vinyl pyridine), poly(4-vinylpyridine), poly(methyl methacrylate), poly(t-butyl methacrylate), poly(acrylic acid), poly(ε-Caprolactone), poly(dimethylsiloxane), poly(n-butyl methyl methacrylate), poly(2-vinyl naphthalene), poly(n-butyl acrylate), poly(t-butyl acrylate), poly(4-hydroxyl styrene), poly(4-methoxy styrene), poly(t-butyl styrene), poly(bipyridylmethyl acrylate), poly(benzyl propylacrylate), 1,2-polybutadiene, 1,4-polybutadiene, poly(ferrocenyldimethylsilane), poly(lactide), poly(vinyl pyrrolidone), poly(D/L-lactide), poly(ethylene oxide), poly(propylene oxide), poly(acrylamide), and poly(ethylene), or a derivative thereof, or a mixture thereof.

The separator may further include a functional group.

The functional group may be one selected from the group consisting of glycidoxypropyltrimethoxysilane, glycidyl methacrylate, glycidyl acrylate, glycidyl ester, glycidyl amine, glycidyl ether, and glycidol, or a derivative thereof, or a mixture thereof.

If the functional group includes glycidyl methacrylate or glycidyl acrylate, at least one additional functional group selected from the group consisting of methyl methacrylate, ethyl methacrylate, n-propyl methacrylate, isopropyl methacrylate, n-butyl methacrylate, t-butyl methacrylate, sec-butyl methacrylate, pentyl methacrylate, 2-ethylhexyl methacrylate, 2-ethyl butyl methacrylate, n-octyl methacrylate, isooctyl methacrylate, isononyl methacrylate, lauryl methacrylate, tetradecyl methacrylate, hydroxy methacrylate, and methacrylic acid may be additionally incorporated.

The average diameter of pores in the separator may be 0.001 to 10 μm.

The porosity of the separator may be 10 to 95 volume percent (vol %) or 30 to 90 volume percent (vol %).

One exemplary embodiment of the present invention provides a method of preparing a separator for a lithium secondary battery, the method including: preparing a block copolymer; incorporating a functional group into the block copolymer; and pores in the block copolymer with the functional group incorporated thereinto.

The block copolymer may be represented by the following Chemical Formula 1 or Chemical Formula 2:

A-block-B [Chemical Formula 1]

A-block-B-block-C [Chemical Formula 2]

where A, B, and C are the same or different, and may be each independently one selected from the group consisting of polystyrene, polyisoprene, poly(2-vinylpyridine), poly(4-vinylpyridine), poly(methyl methacrylate), poly(t-butyl methacrylate), poly(acrylic acid), poly(ε-Caprolactone), poly(dimethylsiloxane), poly(n-butyl methyl methacrylate), poly(2-vinyl naphthalene), poly(n-butyl acrylate), poly(t-butyl acrylate), poly(4-hydroxyl styrene), poly(4-methoxy styrene), poly(t-butyl styrene), poly(bipyridylmethyl acrylate), poly(benzyl propylacrylate), 1,2-polybutadiene, 1,4-polybutadiene, poly(ferrocenyldimethylsilane), poly(lactide), poly(vinyl pyrrolidone), poly(D/L-lactide), poly(ethylene oxide), poly(propylene oxide), poly(acrylamide), and poly(ethylene), or a derivative thereof, or a mixture thereof.

The functional group may be one selected from the group consisting of glycidoxypropyltrimethoxysilane, glycidyl methacrylate, glycidyl acrylate, glycidyl ester, glycidyl amine, glycidyl ether, and glycidol, or a derivative thereof, or a mixture thereof.

In the incorporating of a functional group, the molar ratio of a material containing the functional group and the block copolymer may be 99:1 to 50:50.

The average diameter of pores in the separator for which the pore formation has been completed may be 0.001 to 10 μm.

The porosity of the separator for which the pore formation has been completed may be 10 to 95 volume percent (vol %) or 30 to 90 volume percent (vol %).

The solvent used in the formation of pores may be ethanol.

A separator for a lithium secondary battery according to one exemplary embodiment of the present invention has an interconnected porous network, a highly porous structure, and pores of uniform size.

### Advantageous Effects

Accordingly, ionic conductivity can be improved, and this allows for the production of high-power, high-energy batteries.

Moreover, electrolyte affinity can be improved through the incorporation of a functional group.

In addition, battery performance can be improved by absorbing unnecessary by-products in the electrolyte.

Further, the functional group and block copolymer in the separator for the lithium secondary battery according to one exemplary embodiment of the present invention provides excellent electrolyte solution wettability because they are polar.

### DESCRIPTION OF THE DRAWINGS

FIG. 1 is a view showing a method of preparing a separator for a lithium secondary battery according to one exemplary embodiment of the present invention.

FIG. 2 is an exploded perspective view of a lithium secondary battery according to one exemplary embodiment of the present invention.

FIG. 3A is a scanning electron microscope image of a separator for a lithium secondary battery according to Comparative Example.

FIG. 3B is a scanning electron microscope image of a separator for a lithium secondary battery according to Example 1.

FIG. 3C is a scanning electron microscope image of a separator for a lithium secondary battery according to Example 2.

FIG. 4A is a transmission electron microscope image of a separator prepared before the incorporation of a functional group into poly(styrene-b-2-vinyl pyridine.

FIG. 4B is a transmission electron microscope image of a separator prepared after the incorporation of the functional group used in Example 1.

FIG. 5 is a graph showing measurements of the resistance against AC impedance of the separators prepared according to Examples and of the separator used in Comparative Example.

FIG. 6 is a graph showing observations of the discharge capacity of the lithium secondary batteries manufactured according to Examples and Comparative Example.

FIG. 7 is a graph showing capacity measurements of the lithium secondary batteries manufactured according to Examples and Comparative Example after 50 cycles.

FIG. 8 is a graph showing a result of a manganese absorption test that was performed on the separators prepared according to Examples and Comparative Example.

### MODE FOR INVENTION

Advantages and features of the present invention and methods of accomplishing the same will become more apparent by reference to the following detailed descriptions of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention is defined by the appended claims. Like reference numerals refer to like elements throughout the specification.

Thus, in some embodiments, well-known technologies will not be specifically explained to avoid ambiguous understanding of the present invention. Unless otherwise defined, all terms used in the specification (including technical and scientific terms) may be used with meanings commonly understood by a person having ordinary knowledge in the art. Through the specification, unless explicitly described to the contrary, the word “comprise” and “include” and variations such as “comprises”, “comprising”, “includes”, and “including” will be understood to imply the inclusion of stated elements but not the exclusion of any other elements. In addition, unless specifically described to the contrary, a singular form includes a plural form.

Hereinafter, a separator for a lithium secondary battery according to one exemplary embodiment of the present invention will be described.

A separator for a lithium secondary battery according to one exemplary embodiment of the present invention the present invention includes a block copolymer represented by the following Chemical Formula 1:

A-block-B [Chemical Formula 1]

where A and B are the same or different, and may be each independently one selected from the group consisting of polystyrene, polyisoprene, poly(2-vinylpyridine), poly(4-vinylpyridine), poly(methyl methacrylate), poly(t-butyl methacrylate), poly(acrylic acid), poly(ε-Caprolactone), poly(dimethylsiloxane), poly(n-butyl methyl methacrylate), poly(2-vinyl naphthalene), poly(n-butyl acrylate), poly(t-butyl acrylate), poly(4-hydroxyl styrene), poly(4-methoxy styrene), poly(t-butyl styrene), poly(bipyridylmethyl acrylate), poly(benzyl propylacrylate), 1,2-polybutadiene, 1,4-polybutadiene, poly(ferrocenyldimethylsilane), poly(lactide), poly(vinyl pyrrolidone), poly(D/L-lactide), poly(ethylene oxide), poly(propylene oxide), poly(acrylamide), and poly(ethylene), or a derivative thereof, or a mixture thereof.

Further, a separator for a lithium secondary battery according to another exemplary embodiment of the present invention includes a block copolymer represented by the following Chemical Formula 2:

A-block-B-block-C [Chemical Formula 2]

where A, B, and C are the same or different, and may be each independently one selected from the group consisting of polystyrene, polyisoprene, poly(2-vinylpyridine), poly(4-vinylpyridine), poly(methyl methacrylate), poly(t-butyl methacrylate), poly(acrylic acid), poly(ε-Caprolactone), poly(dimethylsiloxane), poly(n-butyl methyl methacrylate), poly(2-vinyl naphthalene), poly(n-butyl acrylate), poly(t-butyl acrylate), poly(4-hydroxyl styrene), poly(4-methoxy styrene), poly(t-butyl styrene), poly(bipyridylmethyl acrylate), poly(benzyl propylacrylate), 1,2-polybutadiene, 1,4-polybutadiene, poly(ferrocenyldimethylsilane), poly(lactide), poly(vinyl pyrrolidone), poly(D/L-lactide), poly(ethylene oxide), poly(propylene oxide), poly(acrylamide), and poly(ethylene), or a derivative thereof, or a mixture thereof.

The separator may further include a functional group.

The functional group may be one selected from the group consisting of glycidoxypropyltrimethoxysilane, glycidyl methacrylate, glycidyl acrylate, glycidyl ester, glycidyl amine, glycidyl ether, and glycidol, or a derivative thereof, or a mixture thereof.

More specifically, if the block copolymer includes a pyridine group or glycidyl group, the block copolymer may undergo an amide bond-forming reaction with a material containing the functional group to incorporate the functional group into the block copolymer.

Alternatively, if the block copolymer includes a carboxyl group, the block copolymer may undergo an amide-bond forming reaction with a material containing an amine group as the functional group to incorporate the functional group into the block copolymer.

Alternatively, if the block copolymer includes a carboxyl group, the block copolymer may undergo an ester reaction with a material containing a hydroxyl group as the functional group to incorporate the functional group into the block copolymer.

Alternatively, if the block copolymer includes a double bond, the block copolymer may undergo a cross-linking reaction with a material containing a functional group with a double bond to incorporate the functional group into the block copolymer.

If the functional group includes glycidyl methacrylate or glycidyl acrylate, at least one additional functional group selected from the group consisting of methyl methacrylate, ethyl methacrylate, n-propyl methacrylate, isopropyl methacrylate, n-butyl methacrylate, t-butyl methacrylate, sec-butyl methacrylate, pentyl methacrylate, 2-ethylhexyl methacrylate, 2-ethyl butyl methacrylate, n-octyl methacrylate, isooctyl methacrylate, isononyl methacrylate, lauryl methacrylate, tetradecyl methacrylate, hydroxy methacrylate, and methacrylic acid may be incorporated.

The acrylate atoms in the additional functional group may react with and bind to a double bond between acrylate atoms remaining after the bonding between a glycidyl functional group and the block copolymer.

The incorporation of the functional group leads to an increase in swelling volume ratio in the preparation of separators for lithium secondary batteries, thereby enabling the formation of a separator with a highly porous structure. Accordingly, the battery's output characteristics are improved, and this allows for the production of high-power, high-energy batteries.

Moreover, the functional group to be incorporated may be chosen depending on the electrolyte used because the electrolyte affinity differs with the functional group to be incorporated.

Further, when a carboxyl group is on the surface of the separator by the incorporation of the functional group, cations in cathode active material are trapped by electrical attraction, thereby preventing the elution of cations such as Mn²⁺.

In addition, unnecessary by-products from the operation of the lithium secondary battery may be absorbed and removed using the incorporated functional group.

Hereinafter, a method of preparing a separator for a lithium secondary battery according to one exemplary embodiment of the present invention will be described.

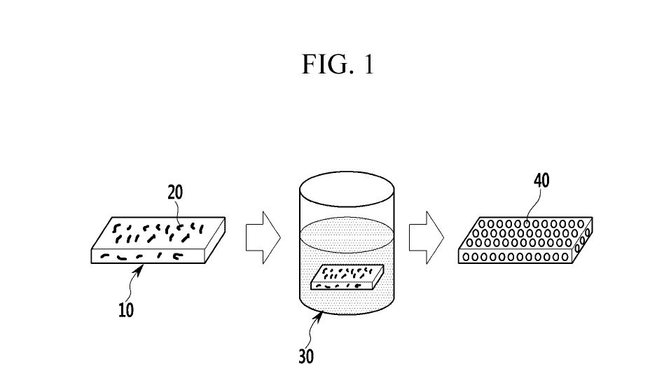

FIG. 1 is a view showing a method of preparing a separator for a lithium secondary battery according to one exemplary embodiment of the present invention.

A method of preparing a separator for a lithium secondary battery according to one exemplary embodiment of the present invention includes: the step of preparing a block copolymer 10; the step of incorporating a functional group into the block copolymer; and the step of pores 40 in the block copolymer with the functional group incorporated into it.

The block copolymer 10 may be a block copolymer represented by the following Chemical Formula 1.

A-block-B [Chemical Formula 1]

where A and B are the same or different, and may be each independently one selected from the group consisting of polystyrene, polyisoprene, poly(2-vinyl pyridine), poly(4-vinylpyridine), poly(methyl methacrylate), poly(t-butyl methactylate), poly(acrylic acid), poly(ε-Caprolactone), poly(dimethylsiloxane), poly(n-butyl methyl methacrylate), poly(2-vinyl naphthalene), poly(n-butyl acrylate), poly(t-butyl acrylate), poly(4-hydroxyl styrene), poly(4-methoxy styrene), poly(t-butyl styrene), poly(bipyridylmethyl acrylate), poly(benzyl propyl acrylate), 1,2-polybutadiene, 1,4-polybutadiene, poly(ferrocenyldimethylsilane), poly(lactide), poly(vinyl pyrrolidone), poly(D/L-lactide), polyethylene oxide), poly(propylene oxide), poly(acrylamide), and poly(ethylene), or a derivative thereof, or a mixture thereof.

The block copolymer 10 may be a block copolymer represented by the following Chemical Formula 2.

A-block-B-block-C [Chemical Formula 2]

where A, B, and C are the same or different, and may be each independently one selected from the group consisting of polystyrene, polyisoprene, poly(2-vinyl pyridine), poly(4-vinylpyridine), poly(methyl methacrylate), poly(t-butyl methacrylate), poly(acrylic acid), poly(ε-Caprolactone), poly(dimethylsiloxane), poly(n-butyl methyl methacrylate), poly(2-vinyl naphthalene), poly(n-butyl acrylate), poly(t-butyl acrylate), poly(4-hydroxyl styrene), poly(4-methoxy styrene), poly(t-butyl styrene), poly(bipyridylmethyl acrylate), poly(benzyl propylacrylate), 1,2-polybutadiene, 1,4-polybutadiene, poly(ferrocenyl dimethyl si lane), poly(lactide), poly(vinyl pyrrolidone), poly(D/L-lactide), poly(ethylene oxide), poly(propylene oxide), poly(acrylamide), and poly(ethylene), or a derivative thereof, or a mixture thereof.

It is preferable that a polymer with a high electrolyte affinity is used as the block copolymer depending on the electrolyte used for the lithium secondary battery in improving the electrochemical performance of the lithium secondary battery.

A material 20 containing a functional group is incorporated into the block copolymer.

The functional group may be one selected from the group consisting of glycidoxypropyltrimethoxysilane, glycidyl methacrylate, glycidyl acrylate, glycidyl ester, glycidyl amine, glycidyl ether, and glycidol, or a derivative thereof, or a mixture thereof.

If the functional group includes glycidyl methacrylate or glycidyl acrylate, at least one additional functional group selected from the group consisting of methyl methacrylate, ethyl methacrylate, n-propyl methacrylate, isopropyl methacrylate, n-butyl methacrylate, t-butyl methacrylate, sec-butyl methacrylate, pentyl methacrylate, 2-ethylhexyl methacrylate, 2-ethyl butyl methacrylate, n-octyl methacrylate, isooctyl methacrylate, isononyl methacrylate, lauryl methacrylate, tetradecyl methacrylate, hydroxy methacrylate, and methacrylic acid may be incorporated.

If the block copolymer includes a pyridine group or glycidyl group, the block copolymer may undergo an amide bond-forming reaction with a material containing the functional group to incorporate the functional group into the block copolymer.

Alternatively, if the block copolymer includes a carboxyl group, the carboxyl group may undergo an amide bond-forming reaction with a material containing an amine group as the functional group to incorporate the functional group into the block copolymer.

Alternatively, if the block copolymer includes a carboxyl group, the block copolymer may undergo an ester reaction with a material containing a hydroxyl group as the functional group to incorporate the functional group into the block copolymer.

Alternatively, if the block copolymer includes a double bond, the block copolymer may undergo a cross-linking reaction with a material containing a functional group to incorporate the functional group into the block copolymer.

The molar ratio of the material containing the functional group and the block copolymer, that is, the molar ratio of the material containing the functional group to the block copolymer, is preferably 99:1 to 50:50. An interconnected porous network may be formed in the separator by using the solvent selectivity of the block copolymer within the above range.

The block copolymer with the functional group incorporated in it is dipped in a solvent 30 to form pores. Pores 50 may be formed by using a solvent having a different solubility for each block of the block copolymer.

The solvent may be selected depending on the incorporated functional group.

For example, polar solvents such as ethanol, water, acetic acid, and alcohol may be used.

Also, in the formation of pores, many different types of pores may be formed according to the chemical structure and molecular weight of the incorporated functional group. More specifically, the lower the molecular weight of the block copolymer, the smaller the pore size.

The average diameter of pores in the separator for which the pore formation has been completed is preferably 0.001 to 10 μm.

If the average diameter of pores is greater than 10 μm, an internal short-circuit may occur, and if the average diameter of pores is less than 0.001 μm, this makes gas permeation and ion conduction through the separator difficult.

If the average pore diameter is within the above range, gas permeability may be controlled to range from 1 to 1,000 seconds per 100 cc air and ionic conductivity may be controlled to range from 10⁻⁶ to 10⁻² S/cm.

The porosity of the separator for which the pore formation has been completed is preferably 10 to 95 volume percent (vol %), more preferably, 30 to 90 volume percent (vol %). The battery can exhibit excellent mechanical strength, as well as excellent ionic conductivity, if the above range is met.

A method of manufacturing a lithium secondary battery according to one exemplary embodiment of the present invention will be described below.

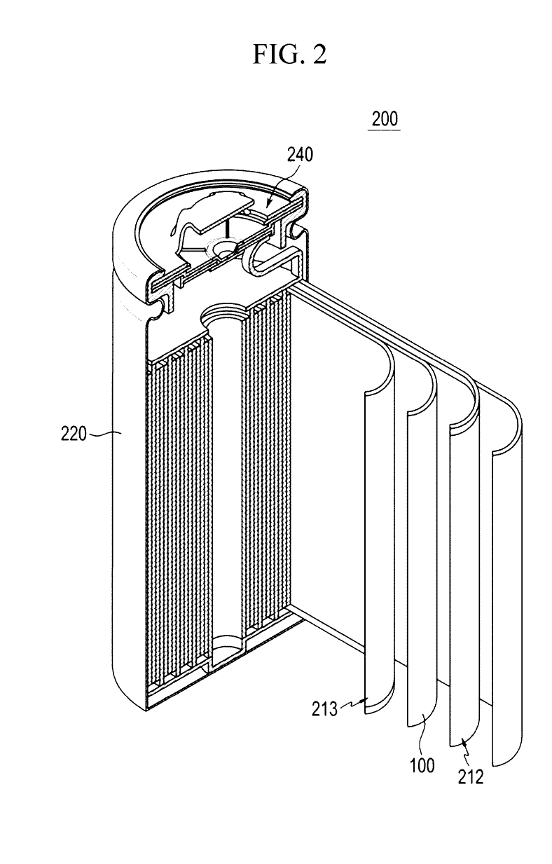

FIG. 2 is an exploded perspective view of a lithium secondary battery according to one exemplary embodiment of the present invention.

Referring to FIG. 2, the lithium secondary battery 100 mainly includes a anode 112, an cathode 114, a separator 113 placed between the anode 112 and cathode 114, an electrolyte (not shown) impregnated into the anode 112, athode 114, and separator 113, a battery case 120, and an encapsulation member 140 for encapsulating the battery case 120.

The anode includes a collector and a anode active material layer formed on the anode, and the anode active material layer includes a anode active material.

Examples of the anode active material include a material capable of reversible intercalation and deintercalation of lithium ions, lithium metal, lithium metal alloy, material used to dope or undope lithium, or transition metal oxide.

The material capable of reversible intercalation and deintercalation of lithium ions may be any one of carbon-based anode active materials that are conventionally used in lithium ion secondary batteries. Examples of the material capable of reversible intercalation and deintercalation of lithium ions are crystalline carbon, amorphous carbon, and a combination thereof. Examples of the crystalline carbon are natural graphite such as amorphous, plate-like, flake, spherical, or fibrous graphite and artificial graphite; and examples of the amorphous carbon are soft carbon (low-temperature calcined carbon), hard carbon, mesophase pitch carbide, and calcined coke.

The lithium metal alloy may be an alloy of lithium with a metal such as Na, K, Rb, Cs, Fr, Be, Mg, Ca, Sr, Si, Sb, Pb, In, Zn, Ba, Ra, Ge, Al or Sn.

The material capable of doping and undoping lithium may be Si, SiOₓ (0<x<2), a Si—C complex, a Si-Q alloy (Q is an alkali metal, an alkaline earth metal, a Group 13 to 16 element, a transition metal, a rare earth element, or a combination thereof, excluding Si), Sn, SnO₂, an Sn—C complex, Sn—R (R is an alkali metal, an alkaline earth metal, a Group 13 to 16 element, a transition metal, a rare earth element, or a combination thereof, excluding Sn), etc. The Q and R elements may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include vanadium oxide, lithium vanadium oxide, etc.

The anode active material layer may also include a binder, and optionally may further include a conductive material.

The binder serves to attach anode active material particles firmly to one another and attach the anode active material firmly to a current collector. Representative examples of the binder may include polyvinyl alcohol, carboxymethyl cellulose, hydroxypropyl cellulose, polyvinyl chloride, carboxylated polyvinyl chloride, polyvinyl fluoride, ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, etc., but the binder is not limited thereto.

The conductive material is used to make the electrodes conductive. As the conductive material, any electro-conductive material may be used as long as chemical changes do not occur in a battery to be configured. Examples of the conductive material may include carbon-based materials such as natural graphite, artificial graphite, carbon black, acetylene black, Ketjen black, carbon fiber; metal-based materials such as metal powders, including copper, nickel, aluminum, and silver, and metal fiber; conductive polymers such as a polyphenylene derivative; or conductive materials including a mixture thereof.

The collector may be copper foil, nickel foil, stainless steel foil, titanium foil, nickel foam, copper foam, a polymer substrate coated with a conductive metal, or a combination thereof.

The cathode includes a current collector and an cathode active material layer formed on the current collector.

A compound (lithiated intercalation compound) capable of reversible intercalation and deintercalation of lithium may be used as the cathode active material. Specifically, one or more types of complex oxides of metal, such as cobalt, manganese, nickel, or a combination thereof, and lithium may be used, and a concrete example of this compound may be a compound represented by any one of the following Chemical Formulae:

LiₐA_{1-b}R_{b}D₂ (where 0.90≦a≦1.8 and 0≦b≦0.5); LiₐE_{1-b}R_{b}O_{2-c}D_{c} (where 0.90≦a≦1.8, 0≦b≦0.5 and 0≦c≦0.05 [symbol] ); LiE_{2-b}R_{b}O_{4-c}D_{c} (where 0≦b≦0.5, 0≦c≦0.05); LiₐNi_{1-b-c}Co_{b}R_{c}D_{α} (where 0.90≦a≦1.8, 0≦b≦0.5, 0≦c≦0.05 and 0<a≦2); LiₐNi_{1-b-c}Co_{b}R_{c}O_{2-α}Z_{α} (where 0.90≦a≦1.8, 0≦b≦0.5, 0≦c≦0.05 and 0<α<2); LiₐNi_{1-b-c}Co_{b}R_{c}O_{2-α}Z₂ (where 0.90≦a≦1.8, 0≦b≦0.5, 0≦c≦0.05 and 0<α<2); LiₐNi_{1-b-c}Mn_{b}R_{c}D_{α} (where 0.90≦a≦1.8, 0≦b≦0.5, 0≦c≦0.05 and 0<a≦2); LiₐNi_{1-b-c}Mn_{b}R_{b}O_{2-α}Z_{α} (where 0.90≦a≦1.8, 0≦b≦0.5, 0≦c≦0.05 and 0<α<2); LiₐNi_{1-b-c}Mn_{b}R_{c}O_{2-α}Z₂ (where 0.90≦a≦1.8, 0≦b≦0.5, 0≦c≦0.05 and 0<α<2); LiₐNi_{b}E_{c}G_{d}O₂ (where 0.90≦a≦1.8, 0≦b≦0.9, 0≦c≦0.5 and 0.001≦d≦0.1); LiₐNi_{b}Co_{c}Mn_{d}GeO₂ (where 0.90≦a≦1.8, 0≦b≦0.9, 0≦c≦0.5, 0≦d≦0.5 and 0.001≦e≦0.1); LiₐNiG_{b}O₂ (where 0.90≦a≦1.8 and 0.001≦b≦0.1); LiₐCoG_{b}O₂ (where 0.90≦a≦1.8 and 0.001≦b≦0.1); LiₐMnG_{b}O₂ (where 0.90≦a≦1.8 and 0.001≦b≦0.1); LiₐMn₂G_{b}O₄ (where 0.90≦a≦1.8 and 0.001≦b≦0.1); QO₂; QS₂; LiQS₂; V₂O₅; LiV₂O₅; LiTO₂; LiNiVO₄; Li_{(3-f)}J₂ PO₄₃ (0≦f≦2); Li_{(3-f)}Fe₂PO₄₃ (0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The compound may have a coating layer on its surface or may be mixed with a compound having a coating layer. The coating layer is a coating element compound, which may include an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be formed by a method having no adverse influence on the properties of the cathode active material by using these elements in the compound. For example, the method may include any coating method as long as the coating layer is formed by spray coating, dipping, etc. This will be well understood by those who work in the related art, so a detailed description of this will be omitted.

Also, the cathode active material layer includes a binder and a conductive material.

The binder serves to attach cathode active material particles firmly to one another and attach the cathode active material firmly to the current collector. Representative examples of the binder may polyvinyl alcohol, carboxylmethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, etc., but the binder is not limited thereto.

The conductive material is used to make the electrodes conductive. Any electro-conductive material may be used as the conductive material as long as chemical changes do not occur in a battery to be configured. Examples of the conductive material may include natural graphite, artificial graphite, carbon black, acetylene black, Ketjen black, carbon fiber, metal powders such as copper, nickel, aluminum, and silver, metal fiber, etc. Also, a mixture of one or more types of conductive materials such as a polyphenylene derivative may be used.

The current collector may be Al but it is not limited thereto.

The anode and the anode each may be prepared by mixing an active material, a conductive material, and a binder together in a solvent to make an active material composition and coating the active material composition on the current collector. Such a method of preparing electrodes is widely known to those skilled in the art, so a detailed description of this will be omitted in this specification. The solvent may include N-methylpyrrolidone, but it is not limited thereto.

The electrolyte includes a non-aqueous organic solvent and a lithium salt.

The non-aqueous organic solvent serves as a medium that allows ions involved in an electrochemical reaction in the battery to travel.

The non-aqueous organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), etc. The ester-based solvent may include methyl acetate, ethyl acetate, n-propyl acetate, 1,1-dimethyl acetate, methylpropinonate, ethylpropinonate, γ-butyrolactone, decanolide, valerolactone, mevalonolactone, caprolactone, etc. The ether-based solvent may include dibutyl ether, tetraglyme, diglyme, dimethoxyethane, 2-methyltetrahydrofuran, tetrahydrofuran, etc. The ketone-based solvent may include cyclohexanone, etc. The alcohol-based solvent may include ethyl alcohol, isopropyl alcohol, etc. The aprotic solvent include nitriles such as R—CN (R is a C2 to C20 linear, branched, or cyclic hydrocarbon group, and may include a double bond, an aromatic ring, or an ether bond), amides such as dimethylformamide, dioxolanes such as 1,3-dioxolane, sulfolanes, etc.

The non-aqueous organic solvent may be used alone or in a mixture. When the organic solvent is used in a mixture, its mixture ratio can be controlled properly according to desired battery performance, which can be well understood by those who work in the related art.

The carbonate-based solvent may include a mixture of cyclic carbonate and chain carbonate. The cyclic carbonate and the chain carbonate may be mixed together in a volume ratio of about 1:1 to about 1:9, which may enhance the performance of the electrolyte solution.

The non-aqueous organic solvent may further include an aromatic hydrocarbon-based organic solvent, in addition to the carbonate-based solvent. The carbonate-based solvent and the aromatic hydrocarbon-based organic solvent may be mixed together in a volume ratio of about 1:1 to about 30:1.

The aromatic hydrocarbon-based organic solvent may be an aromatic hydrocarbon-based compound represented by the following Chemical Formula 3:

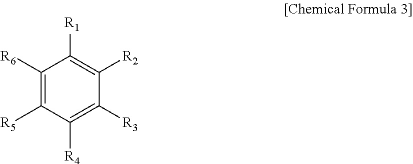

where R₁ to R₆ are each independently hydrogen, halogen, a C1 to C10 alkyl group, a C1 to C10 haloalkyl group, or a combination thereof.

The aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a mixture thereof.

The non-aqueous electrolyte may further include vinylene carbonate or an ethylene carbonate-based compound represented by the following Chemical Formula 4, in order to improve battery cycle:

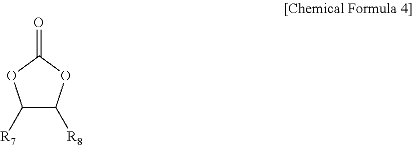

R₇ and R₈ are each independently hydrogen, a halogen group, a cyano group (CN), a nitro group (NO₂), or a C1 to C5 fluoroalkyl group, and at least one of R₇ and R₈ is a halogen group, a cyano group (CN), a nitro group (NO₂), or a C1 to C5 fluoroalkyl group.

Representative examples of the ethylene carbonate-based compound include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, etc. If the non-aqueous electrolyte further includes vinylene carbonate or an ethylene carbonate-based compound, the amount of the vinylene carbonate or ethylene carbonate-based compound used may be properly adjusted in order to improve battery life.

The lithium salt is dissolved in the non-aqueous organic solvent and acts as a supply source of lithium ions in the battery to allow for the basic function of the lithium secondary battery, and facilitates the movement of lithium ions between the anode and anode. Representative examples of the lithium salt include LiPF₆, LiBF₄, LiSbF₆, LiAsF₆, LiC₄F₉SO₃, LiCIO₄, LiAlO₂, LiAlCl₄, LiN(CₓF₂ₓ₊₁SO₂)(C_{y}F_{2y+1}SO₂) (where x and y are natural numbers), LiCl, LiI, LiB(C₂O₄)₂ (lithium bis(oxalato) borate; LiBOB), or a combination thereof. The lithium salt is used as a supporting electrolytic salt. The lithium salt may be used at a concentration of 0.1 M to 2.0 M. If the lithium salt concentration is within the above range, the electrolyte has appropriate conductivity and viscosity and this may lead to excellent electrolyte performance and facilitate the movement of lithium ions.

A separator 100 for a lithium secondary battery according to one exemplary embodiment of the present invention is placed between an cathode 212 including an cathode active material and a anode 213 including a anode active material. Then, the cathode 212, anode 213, and separator 100 for the lithium secondary battery are stored in a battery case 220, an electrolyte (not shown) for the lithium secondary battery is injected, and then the battery case 220 is sealed so that the electrolyte is impregnated into the separator 100 for the lithium secondary battery.

Hereinafter, a method of preparing a separator for a lithium secondary battery and a lithium secondary battery using the separator according to the present invention will be described in detail with reference to some examples. It should be noted that the following examples are only an illustration of this invention and that the scope of the present invention is not limited by the following examples.

### Preparation of Separator for Lithium Secondary Battery and Manufacture of Secondary Battery

### Example 1

Poly(styrene-b-2-vinyl pyridine) as a block copolymer was dissolved in a mixed solvent with a 2:1 ratio by weight of n-methyl-2-pyrrolidone and DMF (dimethylformamide).

Afterwards, glycidoxypropyltrimethoxysilane as a material containing a functional group was added to the mixed solvent so that the block copolymer and the material containing the functional group made up 12 percent by weight in the solvent. The molar ratio between glycidoxypropyltrimethoxysilane and poly(styrene-b-2-vinyl pyridine was 1:1.

The solvent was kept for 1 hour at 120° C. to induce an amide bond-forming reaction, in order to incorporate the functional group into the block copolymer.

The separator thus prepared was cast using a doctor blade and then dried for 10 minutes at 100° C.

The dried separator was dipped in ethanol, a solvent which shows a different solubility for each block of the block copolymer, to form a porous structure.

Afterwards, open pores were formed on the surface by etching both sides by O₂ plasma treatment, thereby preparing a separator with a thickness of 20 μm.

95 wt % of lithium manganese complex oxide (LiMn2O4) as an cathode active material, 2 wt % of carbon black as a conductive agent, and 3 wt % of polyvinylidene fluoride (PVDF) as a binding agent were added to N-methyl-2 pyrrolidone (NMP) as a solvent to prepare an cathode mixture slurry. An cathode was prepared by applying the cathode mixture slurry to an aluminum (Al) thin film with a thickness of 20 μm as an cathode collector and drying it, and then the cathode was roll-pressed.

A anode mixture slurry was prepared by using 88 wt % of lithium titanium oxide (Li4Ti5O12) as a anode active material, 10 wt % of polyvinylidene fluoride (PVDF) as a binding agent, and 2 wt % of carbon black as a conductive agent. A anode was prepared by applying the anode mixture slurry to a copper (Cu) thin film with a thickness of 20 μm as a anode collector and drying it, and then the anode was roll-pressed.

The electrolyte solution used was a non-aqueous electrolyte solution, which was formed by dissolving LiPF₆ to a concentration of 1M in an organic solvent (ethylene carbonate (EC):diethyl carbonate (DEC)=1:1 (v:v)).

The separator for the lithium secondary battery according to Example 1 was placed between the cathode including the cathode active material and the anode including the anode active material, and the electrolyte was injected. After that, a coin-type lithium secondary battery was manufactured.

### Example 2

In the manufacture of a coin-type lithium secondary battery according to Example 2, glycidyl methacrylate was used as a functional group-containing material. The molar ratio between gycidyl methacrylate and poly(styrene-b-2-vinyl pyridine was 1/1 (mol/mol).

A process of manufacturing a coin-type lithium secondary battery is as described in Example 1.

### Comparative Example

As a comparative example, a coin-type lithium secondary battery was manufactured in the same way as the examples by using a polyolefin film (thickness: 20 μm, product of Celgard) as a separator for the lithium secondary battery.

Performance Evaluation

<Evaluation of Physical Properties of Separator>

First, measurements of air permeability (sec/100 cc) and of the amount of impregnation of electrolyte solution were shown in Table 1.

TABLE 1

| | | | | | Amount of |
|---|---|---|---|---|---|
| | | | | | impreg- |
| | | Air | Ionic | Per- | nation of |
| | | permeability | conduc- | centage | electrolyte |
| | Thickness | [s 100 cc | tivity | of voids | solution |
| | [μm] | air⁻¹] | [mS cm⁻¹] | [%] | [%] |
| Comparative | 20 | 500 | 0.734 | 41.0 | 89.7 |
| Example | | | | | |
| Example 1 | 20 | 25 | 0.981 | 55 | 160.6 |
| Example 2 | 20 | 10 | 1.356 | 60 | 180.5 |

The thickness of the separators prepared according to Examples 1 and 2 was around 20 μm, and the separator used in Comparative Example also showed a similar thickness of 20 μm. The air permeability of the separators prepared according to Examples 1 and 2 was 25 and 10 (sec/100 cc), which is a significant increase compared to 500 (sec/100 cc) for the separator of Comparative Example. The amounts of impregnation of electrolyte solution for the separators prepared according to Examples 1 and 2 were 160.6 and 180.5 (volume %), which is higher than 89.7 (volume %) for the separator used in Comparative Example.

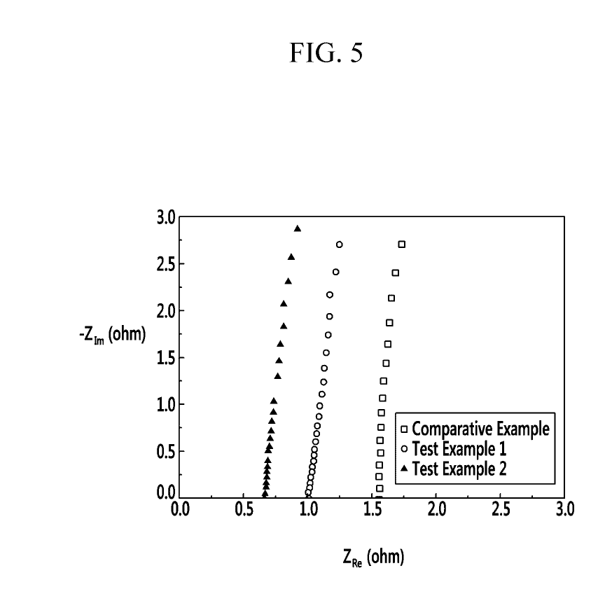

FIG. 5 shows measurements of the resistance versus AC impedance of the separators. The results indicate that Examples 1 and 2 where the porous structure was well-formed showed lower resistance than Comparative Example.

<Observation of Pores>

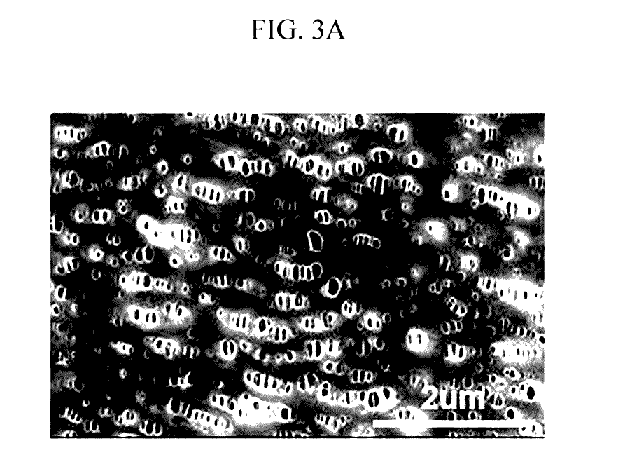

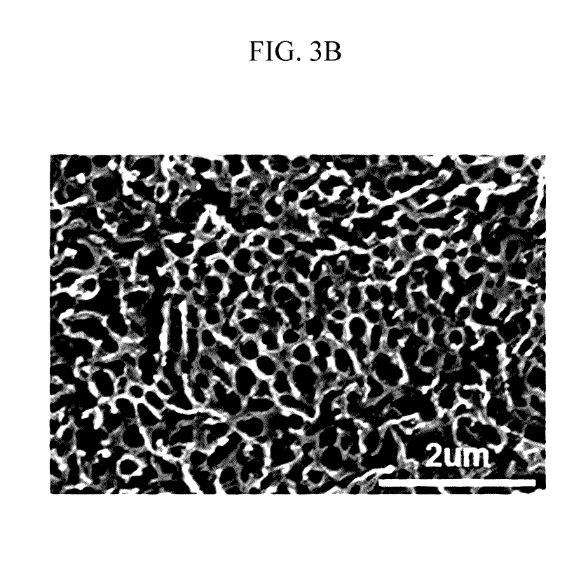

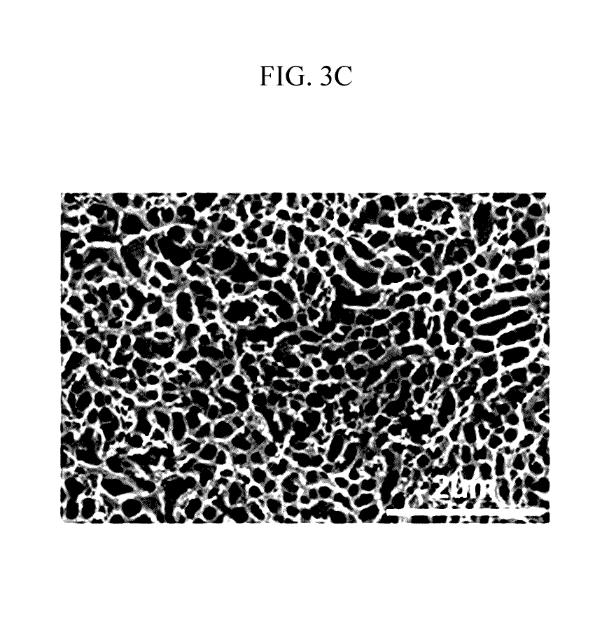

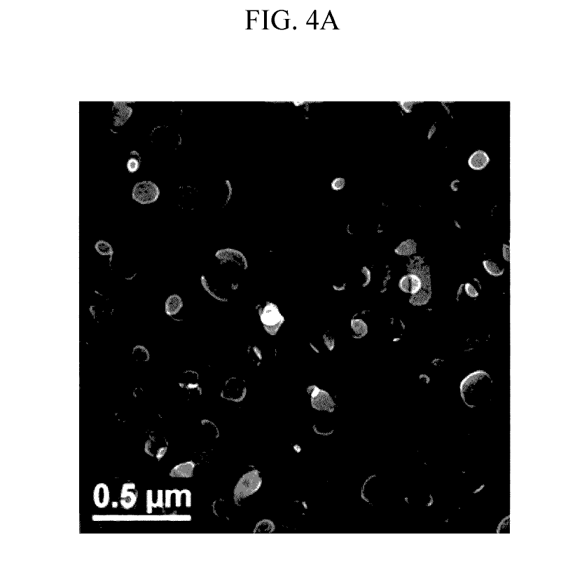

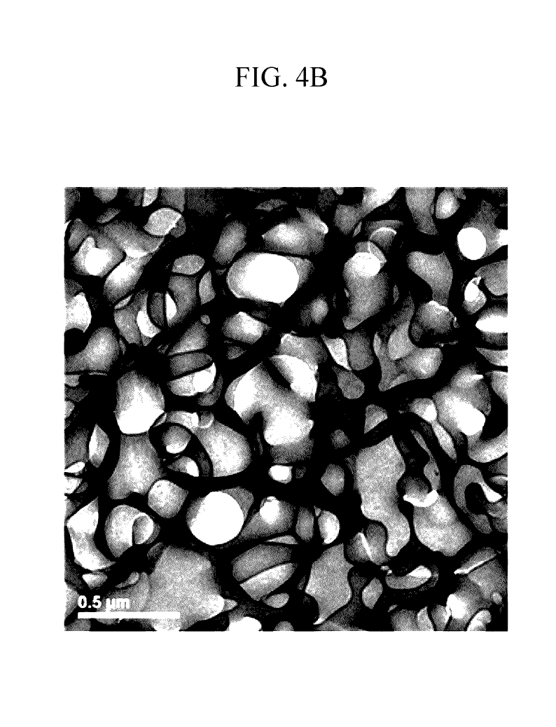

The surfaces of the separators prepared according to Examples and the surface of the separator used in Comparative Example were observed using a scanning electron microscope (SEM) and a transmission electron microscope (TEM), and the results are depicted in FIG. 3. As depicted in FIG. 3B, FIG. 3C, and FIG. 4B, it was observed that the separators prepared according to Examples 1 and 2 had uniform pores.

FIG. 4A is a transmission electron microscope image of a separator prepared before the incorporation of a functional group into poly(styrene-b-2-vinyl pyridine. FIG. 4B is a transmission electron microscope image of a separator prepared after the incorporation of the functional group used in Example 1.

As can be seen from the comparison between FIG. 4A and FIG. 4B, the separator prepared by incorporating a functional group according to the examples of the present invention had more uniform pores.

<Battery Performance Measurement>

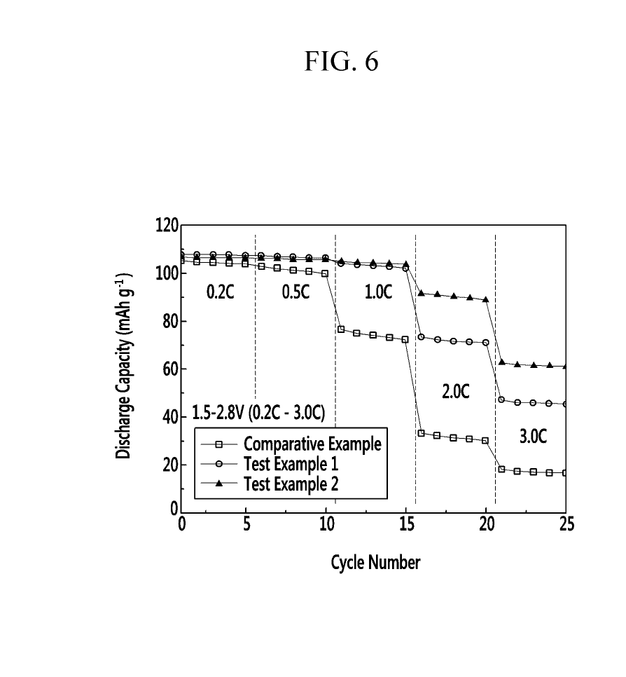

Discharge capacity was observed with increasing coin cell discharge current rate, and the result was shown in FIG. 6. It was observed that the lithium secondary batteries manufactured according to Examples 1 and 2 showed higher discharge capacity than the lithium secondary battery according to Comparative Example.

<Battery Performance Measurement>

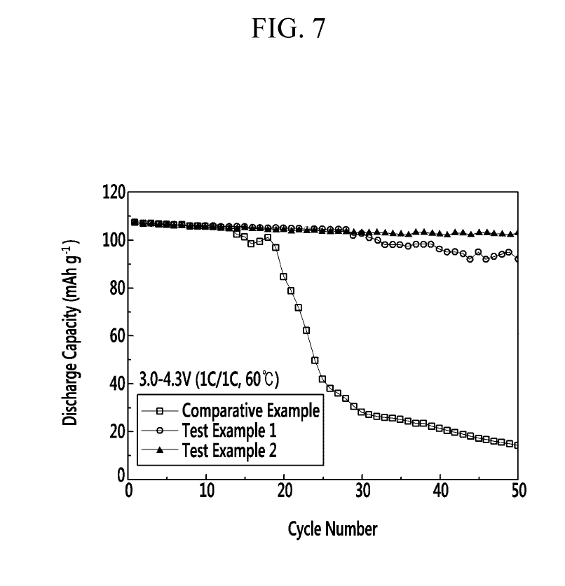

For comparison of the performance of the functional groups in the separators, capacity was measured after 50 cycles under a 60° C. condition where a significant amount of by-products is produced in batteries, and the result was depicted in FIG. 7. Referring to FIG. 7, it can be seen that the lithium secondary batteries manufactured according to Examples 1 and 2 have excellent capacity maintenance than the lithium secondary battery manufactured according to Comparative Example.

In the charge/discharge lifetime test of FIG. 7, lithium metal (Li metal) with a thickness of 200 μm was used as the anode active material.

<Evaluation of By-Product Absorbability>

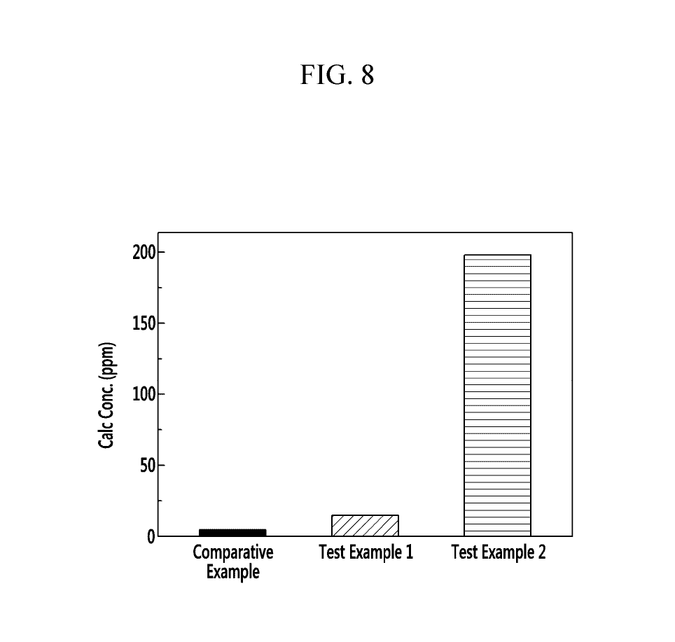

For a more in-depth analysis of the by-product absorbability of the functional groups in the separators, a test of the absorption of manganese ions, which are readily soluble inside batteries, was performed. The separator prepared according to Examples 1 and 2 and the separator prepared according to Comparative Example were kept in a solution with the same amount of manganese ions dissociated from it, for a certain period of time, and then removed, and an ICP elemental analysis was performed. The result is depicted in FIG. 8.

Referring to FIG. 8, it can be seen that the separators prepared according to Examples 1 and 2 absorbed more manganese ions than the separator according to Comparative Example.

While the embodiments of the present invention has been described in detail with reference to the drawings, it will be understood by those skilled in the art that the invention can be implemented in other specific forms without changing the technical spirit or essential features of the invention.

Therefore, it should be noted that the forgoing embodiments are merely illustrative in all aspects and are not to be construed as limiting the invention. The scope of the invention is defined by the appended claims rather than the detailed description of the invention. All changes or modifications or their equivalents made within the meanings and scope of the claims should be construed as falling within the scope of the invention.

### EXPLANATION OF REFERENCE NUMERALS

10: block copolymer
20: functional group-containing material
30: selective solvent
40: pores
100: lithium secondary battery
112: cathode
113: separator
114: anode
120: battery case
140: encapsulation member

1-21. (canceled)

22. A separator for a lithium secondary battery, comprising a block copolymer represented by the following Chemical Formula 1,
wherein a block unit A consisting of some blocks in the block copolymer turns into pores, a functional group is incorporated into a block unit B consisting of some or all blocks in the block copolymer, and the pores are interconnected throughout the separator to create an open porous structure,
A-block-B [Chemical Formula 1]
where A and B are the same or different, and are each independently one selected from the group consisting of polystyrene, polyisoprene, poly(2-vinylpyridine), poly(4-vinylpyridine), poly(methyl methacrylate), poly(t-butyl methacrylate), poly(acrylic acid), poly(ε-Caprolactone), poly(dimethylsiloxane), poly(n-butyl methyl methacrylate), poly(2-vinyl naphthalene), poly(n-butyl acrylate), poly(t-butyl acrylate), poly(4-hydroxyl styrene), poly(4-methoxy styrene), poly(t-butyl styrene), poly(bipyridylmethyl acrylate), poly(benzyl propylacrylate), 1,2-polybutadiene, 1,4-polybutadiene, poly(ferrocenyldimethylsilane), poly(lactide), poly(vinyl pyrrolidone), poly(D/L-lactide), poly(ethylene oxide), poly(propylene oxide), poly(acrylamide), and poly(ethylene), or a derivative thereof, or a mixture thereof.

23. The separator of claim 22, wherein the functional group is one selected from the group consisting of glycidoxypropyltrimethoxysilane, glycidyl methacrylate, glycidyl acrylate, glycidyl ester, glycidyl amine, glycidyl ether, and glycidol, or a derivative thereof, or a mixture thereof.

24. The separator of claim 23, wherein, if the functional group comprises glycidyl methacrylate or glycidyl acrylate, at least one additional functional group selected from the group consisting of methyl methacrylate, ethyl methacrylate, n-propyl methacrylate, isopropyl methacrylate, n-butyl methacrylate, t-butyl methacrylate, sec-butyl methacrylate, pentyl methacrylate, 2-ethylhexyl methacrylate, 2-ethylbutyl methacrylate, n-octyl methacrylate, isooctyl methacrylate, isononyl methacrylate, lauryl methacrylate, tetradecyl methacrylate, hydroxy methacrylate, and methacrylic acid is incorporated.

25. The separator of claim 22, wherein the average diameter of pores in the separator is 0.001 to 10 μm.

26. The separator of claim 22, wherein the porosity of the separator is 55 to 60 volume percent (vol %).

27. A method of preparing a separator for a lithium secondary battery, the method comprising:
preparing a block copolymer represented by the following Chemical Formula 1;
incorporating a functional group into the block copolymer;
preparing a separator by using the block copolymer with the functional group incorporated thereinto; and
obtaining a separator with pores by putting the separator into a solvent having a selective solubility for blocks A and B in the block copolymer; and
obtaining a separator with open pores by plasma-treating the separator with pores,
A-block-B [Chemical Formula 1]
where A and B are the same or different, and are each independently one selected from the group consisting of polystyrene, polyisoprene, poly(2-vinylpyridine), poly(4-vinylpyridine), poly(methyl methacrylate), poly(t-butyl methacrylate), poly(acrylic acid), poly(ε-Caprolactone), poly(dimethylsiloxane), poly(n-butyl methyl methacrylate), poly(2-vinyl naphthalene), poly(n-butyl acrylate), poly(t-butyl acrylate), poly(4-hydroxyl styrene), poly(4-methoxy styrene), poly(t-butyl styrene), poly(bipyridylmethyl acrylate), poly(benzyl propylacrylate), 1,2-polybutadiene, 1,4-polybutadiene, poly(ferrocenyldimethylsilane), poly(lactide), poly(vinyl pyrrolidone), poly(D/L-lactide), poly(ethylene oxide), poly(propylene oxide), poly(acrylamide), and poly(ethylene), or a derivative thereof, or a mixture thereof,
wherein A and B have a different solubility for a particular solvent.

28. The method of claim 27, wherein,
in the incorporating of a functional group into the block copolymer,
the functional group is incorporated into a block unit B consisting of some or all blocks in the block copolymer.

29. The method of claim 28, wherein the functional group is incorporated into the block unit B consisting of some or all blocks in the block copolymer by one or more of the following: an amide bond-forming reaction, an ester reaction, and a cross-linking reaction.

30. The method of claim 27, wherein,
in the incorporating of a functional group into the block copolymer,
the molar ratio of a material containing the functional group and the block copolymer is 99:1 to 50:50.

31. The method of claim 27, wherein the functional group in the functional-group containing material is one selected from the group consisting of glycidoxypropyltrimethoxysilane, glycidyl methacrylate, glycidyl acrylate, glycidyl ester, glycidyl amine, glycidyl ether, and glycidol, or a derivative thereof, or a mixture thereof.

32. The method of claim 27, wherein,
in the obtaining of a separator with pores by putting the separator into a solvent with a selective solubility for blocks A and B in the block copolymer,
a block unit A consisting of some blocks in the block copolymer turns into pores.

33. The method of claim 27, wherein,
in the obtaining of a separator with pores by putting the separator into a solvent having a selective solubility for blocks A and B in the block copolymer,
the solvent having a selective solubility for blocks A and B in the block copolymer is ethanol.

34. The method of claim 27, wherein,
in the obtaining of a separator with open pores by plasma-treating the separator with pores,
the pores are interconnected throughout the separator to create an open porous structure.

35. A lithium secondary battery comprising the separator of claim 22.
